(19) United States
(12) Patent Application Publication
(10) Pub. No.: US 2026/0058504 A1
(43) Pub. Date: Feb. 26, 2026

(54) STATOR CORE

(71) Applicant: FANUC CORPORATION, Yamanashi (JP)

(72) Inventor: Koutarou YAMADA, Yamanashi (JP)

(73) Assignee: FANUC CORPORATION, Yamanashi (JP)

(21) Appl. No.: 19/100,784

(22) PCT Filed: Sep. 6, 2022
(86) PCT No.: PCT/JP2022/033413

§ 371 Date: Feb. 3, 2025

(51) Int. Cl. H02K 1/14; H02K 3/18

(52) U.S. Cl. CPC H02K 1/14; H02K 3/18

(57) ABSTRACT

The stator core according to the present disclosure comprises: a cylindrical circular ring portion; a plurality of tooth portions provided projecting radially outward or radially inward on the circular ring portion; and an insulating portion for insulating between coils provided around the tooth portions adjacent to each other. The insulating portion has a cylindrical holding portion disposed on the circular ring portion and a partition portion that is provided projecting in the radial direction on the holding portion and partitions between the coils adjacent to each other.

### TECHNICAL FIELD

The present disclosure relates to a stator core that is included in, for example, an electric motor,

### BACKGROUND ART

In recent years, coils that are provided in stators of electric motors have become larger in size to achieve higher performance. In this case, there is a possibility that adjacent coils in an electric motor may come into contact with each other while being driven, leading to insulation failure. It has been therefore proposed to include an insulation member between adjacent coils for providing insulation between the adjacent coils.

### CITATION LIST

### Patent Document

Patent Document 1: Japanese Unexamined Patent Application, Publication No. H9-182342

### DISCLOSURE OF THE INVENTION

### Problems to be Solved by the Invention

In the case of a stator including larger coils, gaps between adjacent coils are smaller. The smaller gaps require the insulation member to be made thinner, resulting in reduced rigidity. Having low rigidity, the insulation member is difficult to insert into the gaps between adjacent coils from one side in the axial direction of the stator, because such an insulation member tends to bend upon contact with coils. For this reason, there has been a demand for a stator core having an insulation part that can facilitate compatibility with small gaps between adjacent coils with a simple configuration.

### Means for Solving the Problems

A stator core according to the present disclosure includes: a circular cylindrical ring part; a plurality of teeth provided on the ring part and protruding outward in a radial direction or inward in the radial direction; coils provided on the teeth; and an insulation part that provides insulation between the coils on each pair of adjacent teeth. The insulation part includes a circular cylindrical retainer disposed on the ring part, and separators provided on the retainer and protruding in the radial direction. The separators separate each pair of adjacent coils from each other.

### BRIEF DESCRIPTION OF THE DRAWINGS

FIG. 1 is a schematic perspective view of a stator core in a usable state according to a first embodiment of the present invention;

FIG. 2 is a schematic plan view of the stator core in a usable state according to the first embodiment of the present invention;

FIG. 3 is a schematic perspective view of the stator core according to the first embodiment of the present invention;

FIG. 4 is a schematic perspective view of an insulation part of the stator core according to the first embodiment of the present invention;

FIG. 5 is a schematic perspective view of a stator core according to a second embodiment of the present invention;

FIG. 6 is a schematic plan view of the stator core according to the second embodiment of the present invention;

FIG. 7 is a schematic perspective view of an insulation part of the stator core according to the second embodiment of the present invention;

FIG. 8 is a schematic exploded perspective view of a first modification example of the stator core according to the first embodiment;

FIG. 9 is a schematic exploded perspective view of a first modification example of the stator core according to the second embodiment;

FIG. 10 is a schematic perspective view of a stator core according to a third embodiment of the present invention;

FIG. 11 is a schematic plan view of the stator core according to the third embodiment of the present invention;

FIG. 12 is a schematic perspective view of an inner portion of the stator core according to the third embodiment of the present invention;

FIG. 13 is a schematic perspective view of an insulation part in FIG. 11;

FIG. 14 is a schematic perspective view of an outer portion of the stator core according to the third embodiment of the present invention;

FIG. 15 is a schematic perspective view of an outer ring part in FIG. 14;

FIG. 16 is a schematic perspective view of an insulation part in FIG. 14;

FIG. 17 is a schematic perspective view of a second modification example of the stator core according to the first embodiment;

FIG. 18 is a schematic perspective view of the second modification example of the stator core according to the first embodiment and illustrates a ring part with a portion of an insulation part attached thereto;

FIG. 19 is a schematic perspective view of a portion of the insulation part of the second modification example of the stator core according to the first embodiment;

FIG. 20 is a schematic perspective view of a second modification example of the stator core according to the second embodiment;

FIG. 21 is a schematic perspective view of the second modification example of the stator core according to the second embodiment and illustrates a ring part with a portion of an insulation part attached thereto; and

FIG. 22 is a schematic perspective view of a portion of the insulation part of the second modification example of the stator core according to the second embodiment.

### PREFERRED MODE FOR CARRYING OUT THE INVENTION

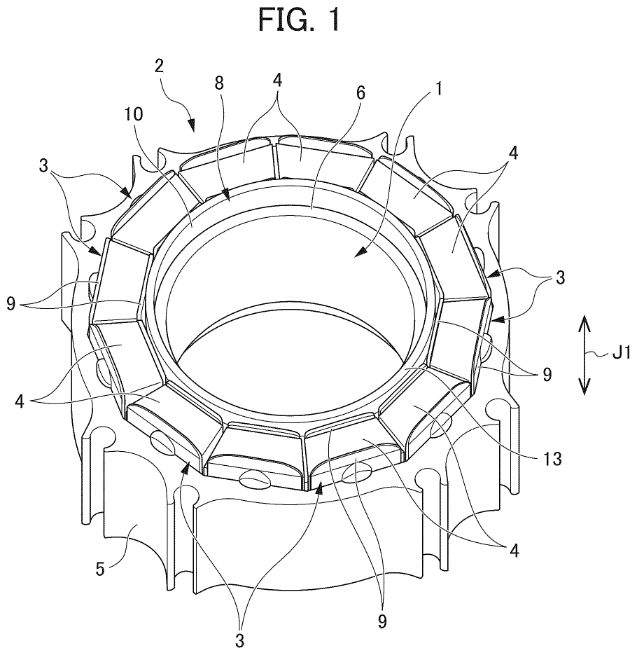

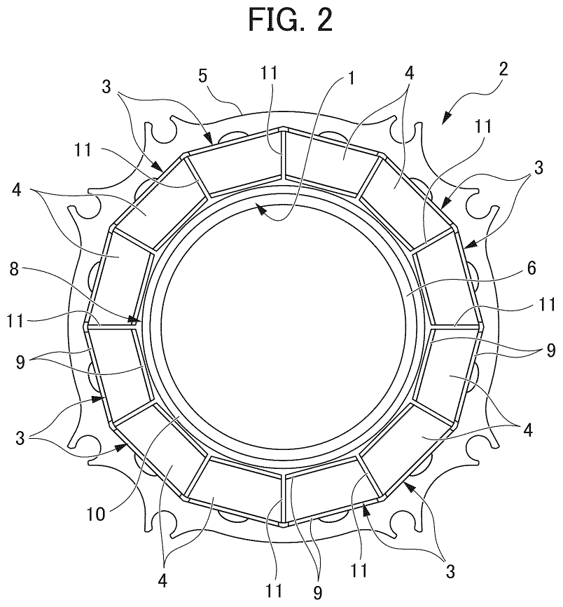

The following describes a stator core according to an embodiment of the present disclosure with reference to the drawings. Referring to FIGS. 1 to 4, a stator 2 including a stator core 1 according to a first embodiment will be described. The stator 2 is used together with a rotor in an electric motor that provides power to a rotating machine. It should be noted that the stator 2 is not limited to being used in an electric motor, and may be used in a generator, for example. The stator 2 includes the stator core 1, bobbins 3, coils 4, and an exterior member 5.

The stator core 1 includes a ring part 6, a plurality of teeth 7, and an insulation part 8. The ring part 6 has a circular cylindrical shape extending in the axial direction J1, and two ends thereof in the axial direction J1 are open. The plurality of teeth 7 are provided on the ring part 6 and protrude outward in the radial direction. Each of the teeth 7 has a plate-like shape along the axial direction J1 of the ring part 6 and protrudes from the outer circumferential surface of the ring part 6 outward in the radial direction. The plurality of teeth 7 are arranged side-by-side in the circumferential direction of the ring part 6. The insulation part 8 is made of resin and prevents insulation failure in the electric motor. The details of a configuration of the insulation part 8 is described below.

Each of the bobbins 3 includes a rectangular cylindrical portion, not shown, and a pair of rectangular plate portions 9. The rectangular cylindrical portion has a substantially rectangular cylindrical shape that is open at two ends in the axial direction thereof. The pair of rectangular plate portions 9 have a plate-like shape and are provided as flanges at the two ends of the rectangular cylindrical portion in the axial direction. Each of the coils 4, which includes windings, is wound around the rectangular cylindrical portion of a corresponding one of the bobbins 3. The coils 4 are attached to the respective teeth 7 by inserting the teeth 7 into the rectangular cylindrical portions of the respective bobbins 3 bearing the coils 4. The rectangular cylindrical portion of each bobbin 3 is mated to the corresponding tooth 7. The coils 4 are attached to the respective teeth 7 as described above, and thus the plurality of coils 4 attached are arranged side-by-side in the circumferential direction in the stator core 1.

The exterior member 5 constitutes an outer portion of the stator 2. The exterior member 5 has a circular cylindrical shape extending in the axial direction J1, and two ends thereof in the axial direction J1 are open. The exterior member 5 is provided so as to cover the outer circumference of the stator core 1 having the coils 4.

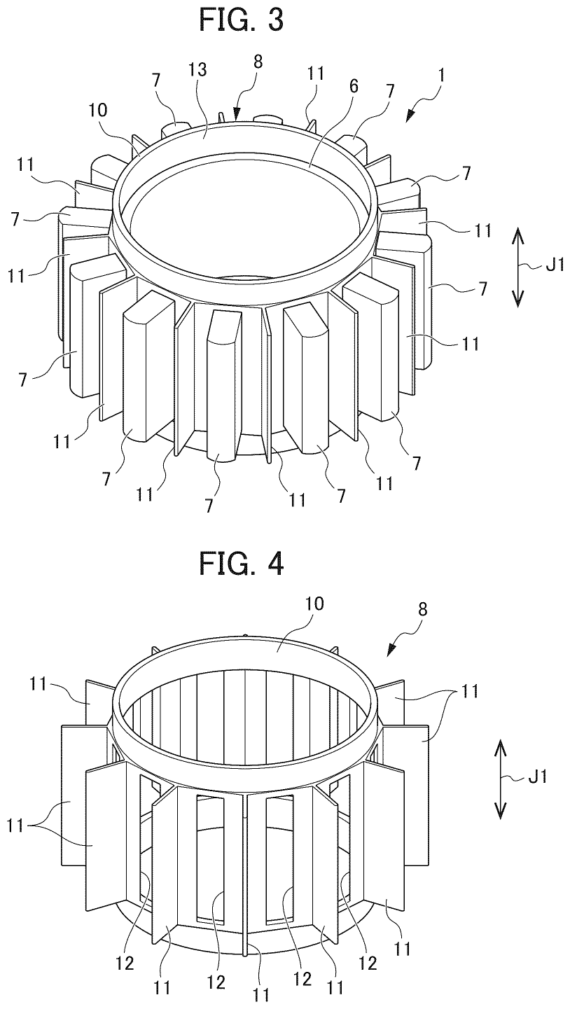

As shown in FIG. 3, the insulation part 8 is provided on the ring part 6. In the first embodiment, the insulation part 8 and the ring part 6 are integrated by insert molding. The insulation part 8 includes a circular cylindrical retainer 10 disposed on the ring part 6, and a plurality of separators 11 provided on the retainer 10 and protruding in the radial direction.

The retainer 10 has a circular cylindrical shape extending in the axial direction J1, and two ends thereof in the axial direction J1 are open. As shown in FIG. 4, the retainer 10 has a plurality of through holes 12 in the circumferential surface thereof. The through holes 12 provide communication between the inside and the outside of the retainer 10. The plurality of through holes 12 are arranged side-by-side in the circumferential direction of the retainer 10.

The plurality of separators 11 are provided on the retainer 10 and protrude outward in the radial direction. Each of the separators 11 has a thin plate-like shape along the axial direction J1 of the retainer 10 and protrudes from the outer circumferential surface of the retainer 10 outward in the radial direction. The plurality of separators 11 are arranged side-by-side in the circumferential direction of the retainer 10. Each of the through holes 12 of the retainer 10 is located between adjacent separators 11.

When the insulation part 8 having the above-described configuration is formed, the ring part 6 and the teeth 7 are attached to the insulation part 8 by insert molding. The ring part 6 is mated to the retainer 10 so that the retainer 10 of the insulation part 8 covers the outer circumferential surface of the ring part 6. In this way, the retainer 10 is disposed on the outer circumference of the ring part 6. When the ring part 6 and the teeth 7 are in their attached positions on the insulation part 8, the teeth 7 extend through the respective through holes 12 of the retainer 10. Each of the separators 1.1 of the insulation part 8 is located between adjacent teeth 7. In the first embodiment, one end 13 of the retainer 10 in the axial direction J1 protrudes from the ring part 6 in one direction in the axial direction J1.

In the case of the stator core 1 according to the first embodiment, the insulation part 8 has the configuration described above, and thus the separators 11 separate each pair of adjacent coils 4 from each other. The insulation part 8 can therefore provide insulation between the coils 4 on each pair of adjacent teeth 7 in the configuration in which the teeth 7 protrude outward in the radial direction of the ring part 6.

In the case of the stator core 1 according to the first embodiment, the one end 13 of the retainer 10 in the axial direction J1 protrudes from the ring part 6 in the one direction in the axial direction J1. Thus, the one end 13 of the retainer 10 in the axial direction J1 functions as a positioning portion when another member is attached to the stator 2.

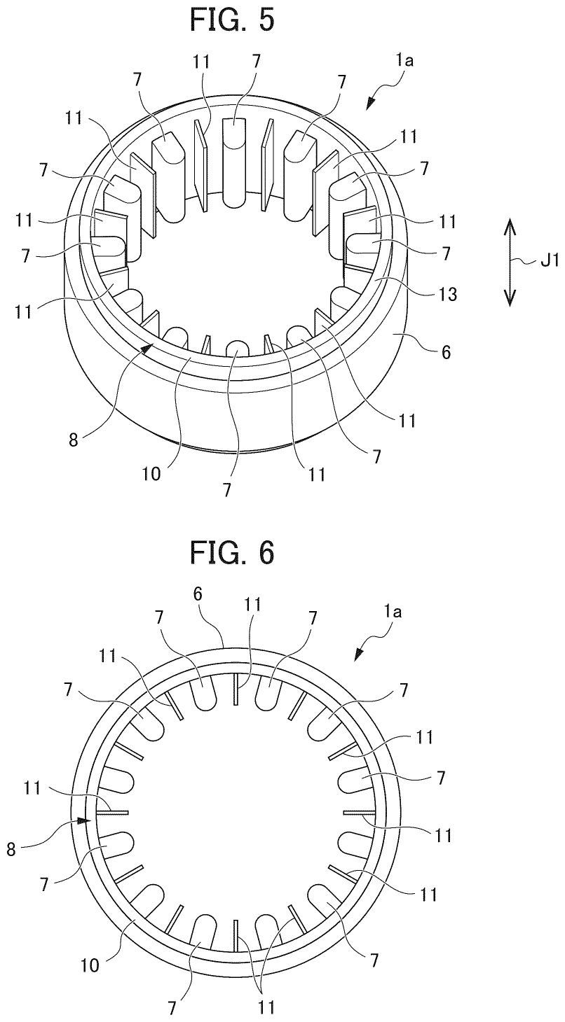

Next, a stator core according to a second embodiment of the present invention will be described with reference to FIGS. 5 to 7. It should be noted that components assigned the same reference numerals as in the first embodiment each have the same function as described in the first embodiment, and thus description thereof may be omitted below. A stator core la of the second embodiment differs from that of the first embodiment in the configuration of the teeth 7. Consequently, the stator core 1a of the second embodiment differs from that of the first embodiment also in the configuration of the insulation part 8.

A plurality of teeth 7 are provided on a circular cylindrical ring part 6 and protrude inward in the radial direction. Each of the teeth 7 has a plate-like shape along the axial direction J1 of the ring part 6 and protrudes from the inner circumferential surface of the ring part 6 inward in the radial direction. The plurality of teeth 7 are arranged side-by-side in the circumferential direction of the ring part 6.

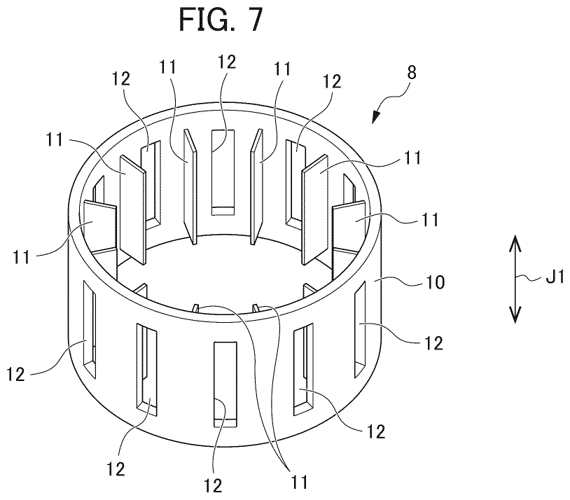

The stator core 1a has an insulation part 8 that includes a circular cylindrical retainer 10 and a plurality of separators 11 provided on the retainer 10. The retainer 10 has a circular cylindrical shape extending in the axial direction J1, and two ends thereof in the axial direction J1 are open. As shown in FIG. 7, the retainer 10 has a plurality of through holes 12 in the circumferential surface thereof. The through holes 12 provide communication between the inside and the outside of the retainer 10. The plurality of through holes 12 are arranged side-by-side in the circumferential direction of the retainer 10. The plurality of separators 11 are provided on the retainer 10 and protrude inward in the radial direction. Each of the separators 11 has a thin plate-like shape along the axial direction J1 of the retainer 10 and protrudes from the inner circumferential surface of the retainer 10 inward in the radial direction. The plurality of Separators 11 are arranged side-by-side in the circumferential direction of the retainer 10. Each of the through holes 12 of the retainer 10 is located between adjacent separators 11.

When the insulation part 8 having the above-described configuration is formed, the ring part 6 and the teeth 7 are attached to the insulation part 8 by insert molding. The ring part 6 is mated to the retainer 10 so that the retainer 10 of the insulation part 8 covers the inner circumferential surface of the ring part 6. In this way, the retainer 10 is disposed on the inner circumference of the ring part 6. When the ring part 6 and the teeth 7 are in their attached positions on the insulation part 8, the teeth 7 extend through the respective through holes 12 of the retainer 10. Each of the separators 11 of the insulation part 8 is located between adjacent teeth 7. In the second embodiment, one end 13 of the retainer 10 in the axial direction J1 protrudes from the ring part 6 in the one direction in the axial direction J1.

Although not shown, coils 4 are attached to the teeth 7 of the stator core 1a in the same manner as in the first embodiment described above. In the case of the stator core 1a according to the second embodiment, the insulation part 8 has the configuration described above, and thus the separators 11 separate each pair of adjacent coils 4 from each other. The insulation part 8 can therefore provide insulation between the coils 4 on each pair of adjacent teeth 7 in the configuration in which the teeth 7 protrude inward in the radial direction of the ring part 6.

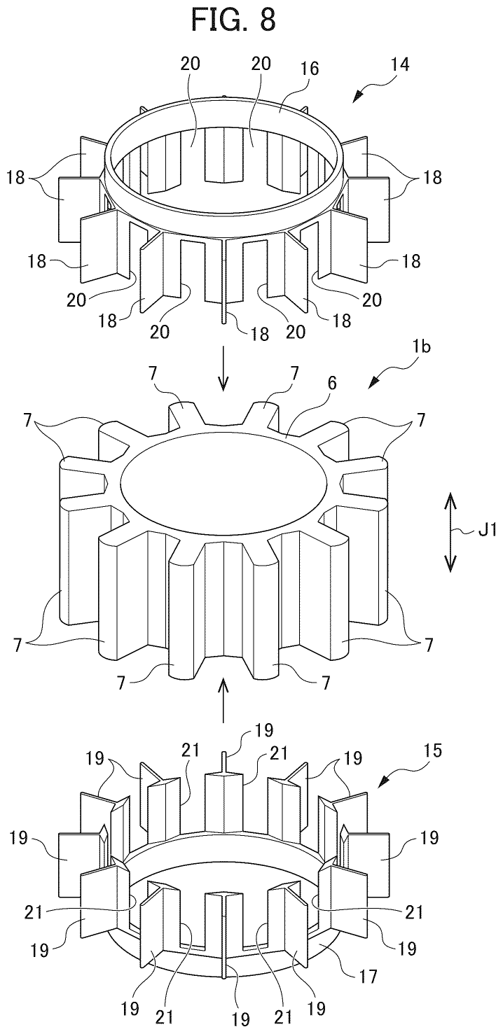

Next, a first modification example of the stator core according to the first embodiment will be described with reference to FIG. 8. It should be noted that components assigned the same reference numerals as in the first embodiment each have the same function as described in the first embodiment, and thus description thereof may be omitted below. A stator core 1b of the present modification example differs from that of the first embodiment in the configuration of the insulation part 8.

The stator core 1b has an insulation part 8 that is divisible into two parts that can be separated from each other in the axial direction J1 of a retainer 10 thereof. Specifically, the insulation part 8 includes a first insulation part 14 that is disposed at one end of a ring part 6 in the axial direction J1, and a second insulation part 15 that is disposed at an opposite end of the ring part 6 in the axial direction J1. In this case, the retainer 10 includes a first retainer 16 that is located at the one end in the axial direction J1 and a second retainer 17 that is located at the opposite end in the axial direction J1. The insulation part 8 has separators 11 including first separators 18 that are located at the one end in the axial direction J1 and second separators 19 that are located at the opposite end in the axial direction J1.

The first insulation part 14 includes the first retainer 16 having a circular cylindrical shape and the plurality of first separators 18 provided on the first retainer 16. The first retainer 16 has a circular cylindrical shape extending in the axial direction J1, and two ends thereof in the axial direction J1 are open. The first retainer 16 has a plurality of notches 20 that open in the opposite direction in the axial direction J1 of the first retainer 16. The plurality of notches 20 are arranged side-by-side in the circumferential direction of the first retainer 16. The plurality of first separators 18 are provided on the first retainer 16 and protrude outward in the radial direction. Each of the first Separators 18 has a thin plate-like shape along the axial direction J1 of the first retainer 16 and protrudes from the outer circumferential surface of the first retainer 16 outward in the radial direction. The plurality of first separators 18 are arranged side-by-side in the circumferential direction of the first retainer 16. Each of the notches 20 of the first retainer 16 is located between adjacent first separators 18.

The second insulation part 15 includes the second retainer 17 having a circular cylindrical shape and the plurality of second separators 19 provided on the second retainer 17. The second retainer 17 has a circular cylindrical shape extending in the axial direction J1, and two ends thereof in the axial direction J1 are open. The second retainer 17 has a plurality of notches 21 that open in the one direction in the axial direction J1 of the second retainer 17. The plurality of notches 21 are arranged side-by-side in the circumferential direction of the second retainer 17. The plurality of second separators 19 are provided on the second retainer 17 and protrude outward in the radial direction. Each of the second separators 19 has a thin plate-like shape along the axial direction J1 of the second retainer 17 and protrudes from the outer circumferential surface of the second retainer 17 outward in the radial direction. The plurality of second separators 19 are arranged side-by-side in the circumferential direction of the second retainer 17. Each of the notches 21 of the second retainer 17 is located between adjacent second Separators 19. It should be noted that the second insulation part 15 may have the same configuration as the first insulation part 14. In this is the case, the second insulation part 15 is used in an opposite orientation to the first insulation part 14.

The insulation part 8 having the configuration described above is provided on the ring part 6 by mating the first insulation part 14 to the one end of the ring part 6 in the axial direction J1 and mating the second insulation part 15 to the opposite end of the ring part 6 in the axial direction J1. When the first insulation part 14 is mated to the ring part 6, the first retainer 16 is attached to the ring part 6 so as to cover an area of the outer circumferential surface of the ring part 6 toward the one end in the axial direction J1. At the same time, one end of each tooth 7 in the axial direction J1 is inserted into a corresponding one of the notches 20 of the first retainer 16. When the second insulation part 15 is mated to the ring part 6, the second retainer 17 is attached to the ring part 6 so as to cover an area of the outer circumferential surface of the ring part 6 toward the opposite end in the axial direction J1. At the same time, an opposite end of each tooth 7 in the axial direction J1 is inserted into a corresponding one of the notches 21 of the second retainer 17.

When the first insulation part 14 and the second insulation part 15 are in their mated positions on the ring part 6, an end surface of the first retainer 16 toward the opposite end in the axial direction J1 is in contact with an end surface of the second retainer 17 toward the one end in the axial direction J1. When the first insulation part 14 and the second insulation part 15 are in their mated positions on the ring part 6, the first separators 18 and the second separators 19 are contiguous with each other with plate surfaces thereof facing each other in order. When the insulation part 8 is in its attached position on the ring part 6 as described above, the teeth 7 extend through respective through holes 12, which are defined by the notches 20 of the first insulation part 14 and the notches 21 of the second insulation part 15. Each of the separators 11, which each include one of the first separators 18 and a corresponding one of the second separators 19, is located between adjacent teeth 7.

In the case of the stator core 1b according to the present modification example, the insulation part 8 is configured to be divisible into two parts that can be separated from each other in the axial direction J1 of the retainer 10. As such, the stator core 1b according to the present modification example has a configuration in which the insulation part 8 is divisible into two parts that can be separated from each other, and these two parts are united into one part, so that the teeth 7 protrude from the ring part 6 outward in the radial direction. This configuration facilitates the attachment of the insulation part 8 to the ring part 6 without using insert molding.

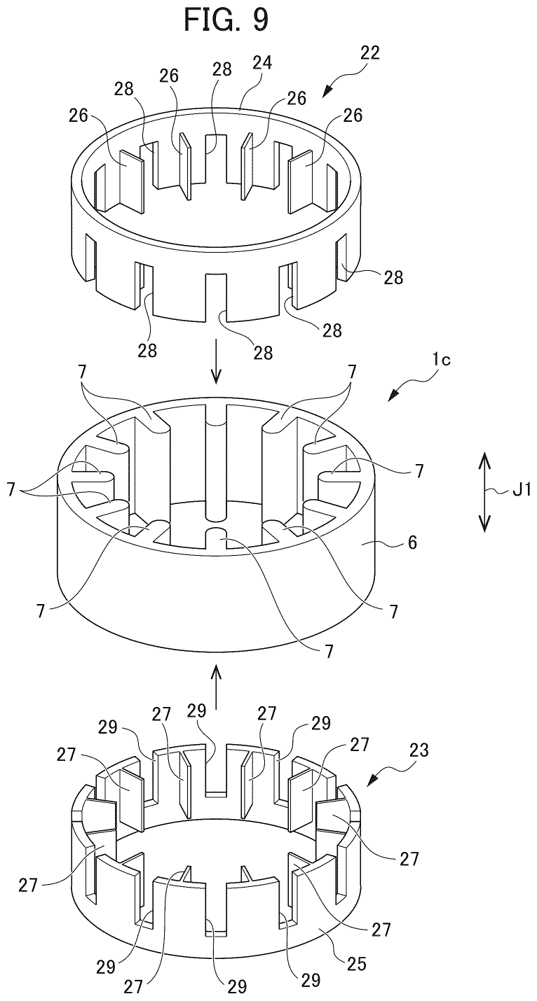

Next, a first modification example of the stator core according to the second embodiment will be described with reference to FIG. 9. It should be noted that components assigned the same reference numerals as in the first and second embodiments each have the same function as described in the first and second embodiments, and thus description thereof may be omitted below. A stator core 1c of the present modification example differs from that of the second embodiment in the configuration of the insulation part 8.

The stator core 1c has an insulation part 8 that is divisible into two parts that can be separated from each other in the axial direction J1 of a retainer 10 thereof. Specifically, the insulation part 8 includes a first insulation part 22 that is disposed at one end of a ring part 6 in the axial direction J1, and a second insulation part 23 that is disposed at an opposite end of the ring part 6 in the axial direction J1. In this case, the retainer 10 includes a first retainer 24 that is located at the one end in the axial direction J1 and a second retainer 25 that is located at the opposite end in the axial direction J1. The insulation part 8 has separators 11 including first separators 26 that are located at the one end in the axial direction J1 and second separators 27 that are located at the opposite end in the axial direction J1.

The first insulation part 22 includes the first retainer 24 having a circular cylindrical shape and the plurality of first separators 26 provided on the first retainer 24. The first retainer 24 has a circular cylindrical shape extending in the axial direction J1, and two ends thereof in the axial direction J1 are open. The first retainer 24 has a plurality of notches 28 that open in the opposite direction in the axial direction J1 of the first retainer 24. The plurality of notches 28 are arranged side-by-side in the circumferential direction of the first retainer 24. The plurality of first separators 26 are provided on the first retainer 24 and protrude inward in the radial direction. Each of the first separators 26 has a thin plate-like shape along the axial direction J1 of the first retainer 24 and protrudes from the inner circumferential surface of the first retainer 24 inward in the radial direction. The plurality of first separators 26 are arranged side-by-side in the circumferential direction of the first retainer 24. Each of the notches 28 of the first retainer 24 is located between adjacent first separators 26.

The second insulation part 23 includes the second retainer 25 having a circular cylindrical shape and the plurality of second separators 27 provided on the second retainer 25. The second retainer 25 has a circular cylindrical shape extending in the axial direction J1, and two ends thereof in the axial direction J1 are open. The second retainer 25 has a plurality of notches 29 that open in the one direction in the axial direction J1 of the second retainer 25. The plurality of notches 29 are arranged side-by-side in the circumferential direction of the second retainer 25. The plurality of second separators 27 are provided on the second retainer 25 and protrude inward in the radial direction. Each of the second separators 27 has a thin plate-like shape along the axial direction J1 of the second retainer 25 and protrudes from the inner circumferential surface of the second retainer 25 inward in the radial direction. The plurality of second separators 27 are arranged side-by-side in the circumferential direction of the second retainer 25. Each of the notches 29 of the second retainer 25 is located between adjacent second separators 27. It should be noted that the second insulation part 23 may have the same configuration as the first insulation part 22. In this case, the second insulation part 23 is used in an opposite orientation to the first insulation part 22.

The insulation part 8 having the configuration described above is provided on the ring part 6 by mating the first insulation part 22 to the one end of the ring part 6 in the axial direction J1 and mating the second insulation part 23 to the opposite end of the ring part 6 in the axial direction J1. When the first insulation part 22 is mated to the ring part 6, the first retainer 24 is attached to the ring part 6 so as to cover an area of the inner circumferential surface of the ring part 6 toward the one end in the axial direction J1. At the same time, one end of each tooth 7 in the axial direction J1 is inserted into a corresponding one of the notches 28 of the first retainer 24. When the second insulation part 23 is mated to the ring part 6, the second retainer 25 is attached to the ring part 6 so as to cover an area of the inner circumferential surface of the ring part 6 toward the opposite end in the axial direction J1. At the same time, an opposite end of each tooth 7 in the axial direction J1 is inserted into a corresponding one of the notches 29 of the second retainer 25.

When the first insulation part 22 and the second insulation part 23 are in their mated positions on the ring part 6, an end surface of the first retainer 24 toward the opposite end in the axial direction J1 is in contact with an end surface of the second retainer 25 toward the one end in the axial direction J1. When the first insulation part 22 and the second insulation part 23 are in their mated positions on the ring part 6, the first separators 26 and the second separators 27 are contiguous with each other with plate surfaces thereof facing each other in order. When the insulation part 8 is in its attached position on the ring part 6 as described above, the teeth 7 extend through respective through holes 12, which are defined by the notches 28 of the first insulation part 22 and the notches 29 of the second insulation part 23. Each of the separators 11, which each include one of the first separators 26 and a corresponding one of the second separators 27, is located between adjacent teeth 7.

In the case of the stator core 1c according to the present modification example, the insulation part 8 is configured to be divisible into two parts that can be separated from each other in the axial direction J1 of the retainer 10. As such, the stator core 1c according to the present modification example has a configuration in which the insulation part 8 is divisible into two parts that can be separated from each other, and these two parts are united into one part, so that the teeth 7 protrude from the ring part 6 inward in the radial direction. This configuration facilitates the attachment of the insulation part 8 to the ring part 6.

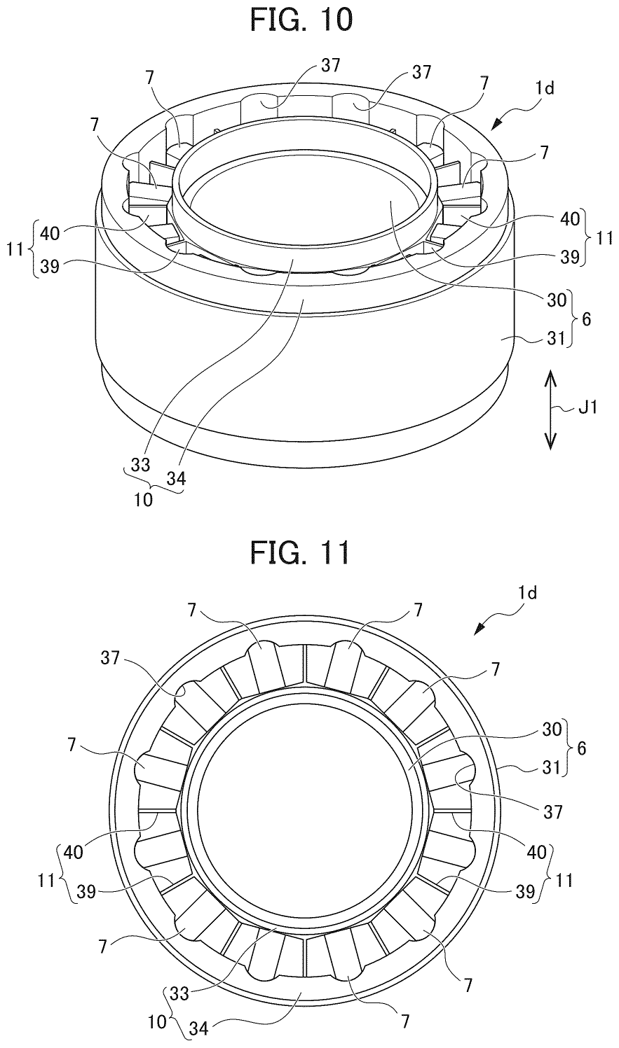

Next, a stator core according to a third embodiment of the present invention will be described with reference to FIGS. 10 to 16. It should be noted that components assigned the same reference numerals as in the first embodiment each have the same function as described in the first embodiment, and thus description thereof may be omitted below. A stator core 1d of the third embodiment differs from that of the first embodiment in the configuration of the ring part 6. Consequently, the stator core Id of the third embodiment differs from that of the first embodiment also in the configuration of the insulation part 8.

The stator core 1d has a ring part 6 including an inner ring part 30 and an outer ring part 31 that are arranged one inside the other in a nested manner. The inner ring part 30 has a circular cylindrical shape extending in the axial direction J1, and two ends thereof in the axial direction J1 are open. The outer ring part 31 has a circular cylindrical shape extending in the axial direction J1, and two ends thereof in the axial direction J1 are open. The inner diameter of the outer ring part 31 is larger than the outer diameter of the inner ring part 30. The inner circumferential surface of the outer ring part 31 has a plurality of grooves 32. Each of the grooves 32 is recessed outward in the radial direction of the outer ring part 31 and extends in the axial direction J1 of the outer ring part 31. The plurality of grooves 32 are arranged side-by-side in the circumferential direction of the outer ring part 31.

A plurality of teeth 7 are provided on the inner ring part 30 and protrude outward in the radial direction. Each of the teeth 7 has a plate-like shape along the axial direction J1 of the inner ring part 30 and protrudes from the outer circumferential surface of the inner ring part 30 outward in the radial direction. The plurality of teeth 7 are arranged side-by-side in the circumferential direction of the inner ring part 30.

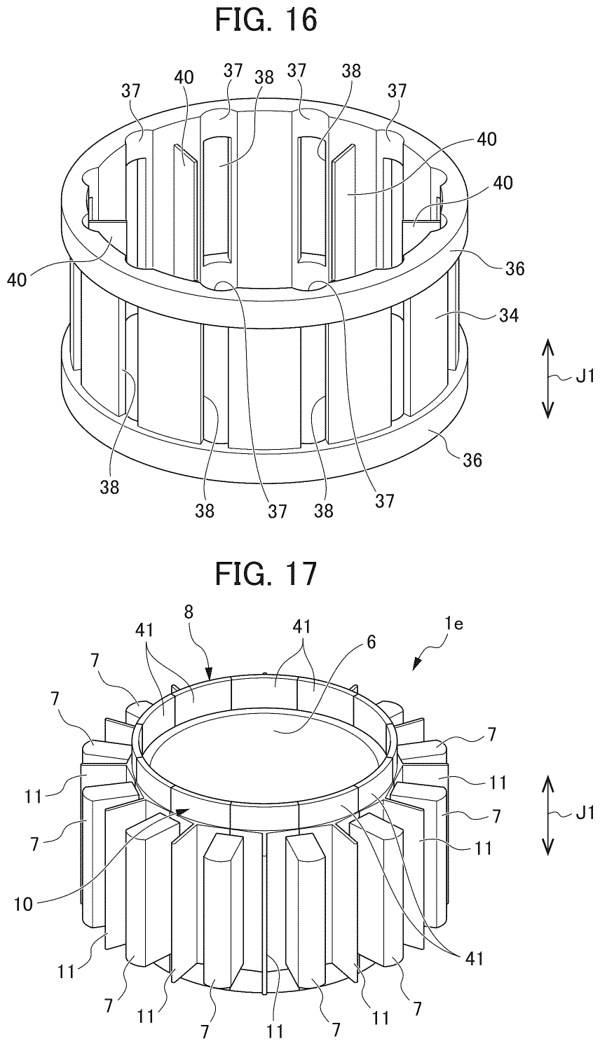

The retainer 10 includes an inner retainer 33 that is disposed on the inner ring part 30 and an outer retainer 34 that is disposed on the outer ring part 31. The inner retainer 33 has a circular cylindrical shape extending in the axial direction J1, and two ends thereof in the axial direction J1 are open. As shown in FIG. 13, the inner retainer 33 has a plurality of through holes 35 in the circumferential surface thereof. The through holes 35 provide communication between the inside and the outside of the inner retainer 33. The plurality of through holes 35 are arranged side-by-side in the circumferential direction of the inner retainer 33. The outer retainer 34 has a circular cylindrical shape extending in the axial direction J1, and two ends thereof in the axial direction J1 are open. As shown in FIG. 16, the outer retainer 34 has, at the two ends thereof in the axial direction J1, annular flanges 36 extending outward in the radial direction. The inner circumferential surface of the outer retainer 34 has a plurality of grooves 37. Each of the grooves 37 is recessed outward in the radial direction of the outer retainer 34 and extends in the axial direction J1 of the outer retainer 34. The plurality of grooves 37 are arranged side-by-side in the circumferential direction of the outer retainer 34. The outer retainer 34 has a plurality of through holes 38 in the circumferential surface thereof. The through holes 38 penetrate through bottom surfaces of the respective grooves 37, and provide communication between the inside and the outside of the outer retainer 34.

The stator core 1d has a plurality of separators 11 that includes inner separators 39 provided on the inner retainer 33 and outer separators 40 provided on the outer retainer 34. The plurality of inner separators 39 are provided on the inner retainer 33 and protrude outward in the radial direction. Each of the inner separators 39 has a thin plate-like shape along the axial direction J1 of the inner retainer 33 and protrudes from the outer circumferential surface of the inner retainer 33 outward in the radial direction. The plurality of inner separators 39 are arranged side-by-side in the circumferential direction of the inner retainer 33. Two through holes 35 of the inner retainer 33 are located between each pair of adjacent inner separators 39. The plurality of outer separators 40 are provided on the outer retainer 34 and protrude inward in the radial direction. Each of the outer separators 40 has a thin plate-like shape along the axial direction J1 of the outer retainer 34 and protrudes from the inner circumferential surface of the outer retainer 34 inward in the radial direction. The plurality of outer separators 40 are arranged side-by-side in the circumferential direction of the outer retainer 34. Two through holes 38 of the outer retainer 34 are located between each pair of adjacent outer separators 40.

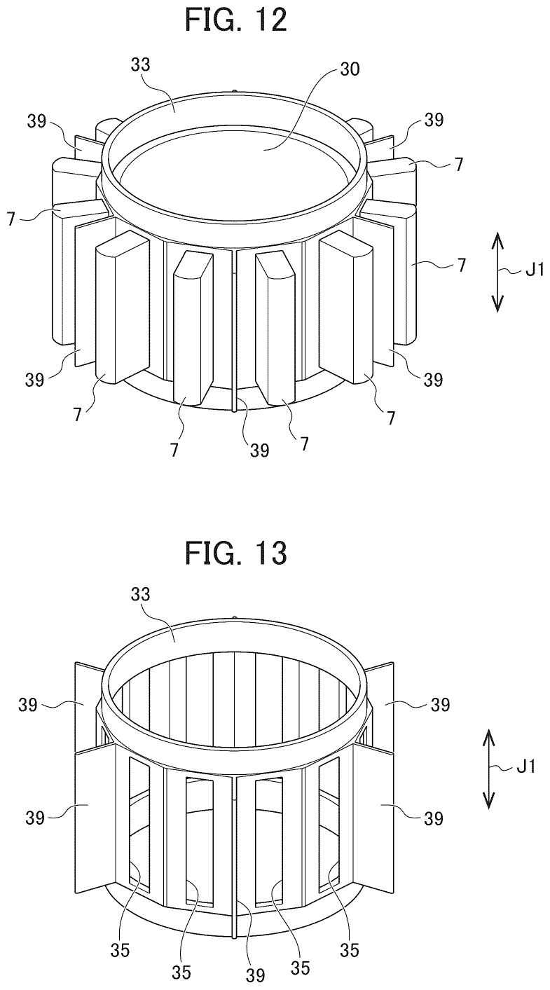

As shown in FIG. 12, the inner retainer 33 having the inner separators 39 is provided on the inner ring part 30. In the third embodiment, the inner ring part 30 and the inner retainer 33 having the inner separators 39 are integrated by insert molding. Specifically, when the inner retainer 33 having the inner separators 39 is formed, the inner ring part 30 and the teeth 7 are attached to the inner retainer 33 by insert molding. The inner ring part 30 is mated to the inner retainer 33 so that the inner retainer 33 covers the outer circumferential surface of the inner ring part 30. In this way, the inner retainer 33 is disposed on the outer circumference of the inner ring part 30. When the inner ring part 30 and the teeth 7 are in their attached positions on the inner retainer 33, the teeth 7 extend through the respective through holes 35 of the inner retainer 33. As described above, two through holes 35 of the inner retainer 33 are located between each pair of adjacent inner separators 39. Therefore, when the inner ring part 30 and the teeth 7 are in their attached positions on the inner retainer 33, spaces between the teeth 7 adjacent to each other where the inner separators 39 are located and spaces between the teeth 7 adjacent to each other where the inner separators 39 are not located are arranged alternately in the circumferential direction.

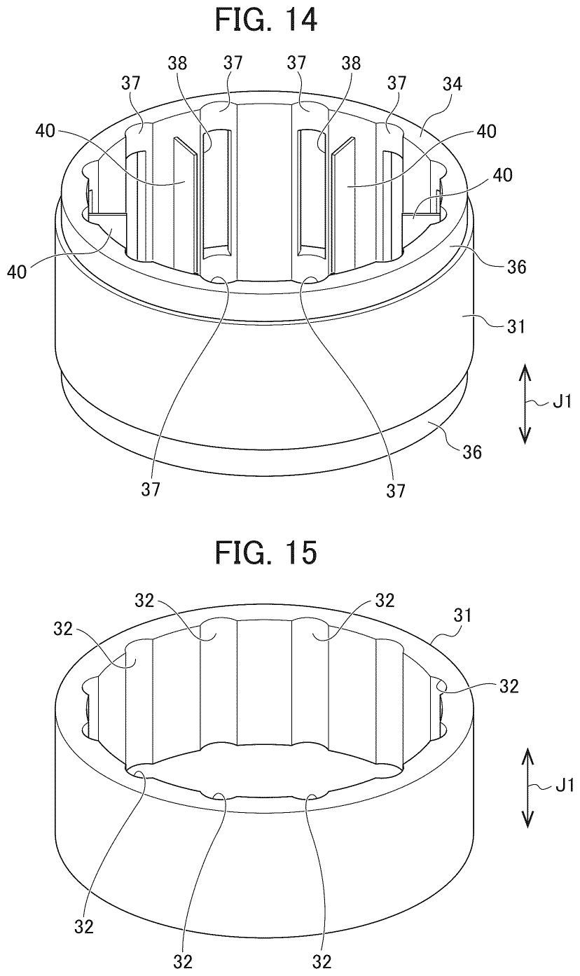

As shown in FIG. 14, the outer retainer 34 having the outer separators 40 is provided on the outer ring part 31. In the third embodiment, the outer ring part 31 and the outer retainer 34 having the outer separators 40 are integrated by insert molding. Specifically, when the outer retainer 34 having the outer separators 40 is formed, the outer ring part 31 is attached to the outer retainer 34 by insert molding. The outer ring part 31 is mated to the outer retainer 34 so that the outer retainer 34 covers the inner circumferential surface of the outer ring part 31. In this way, the outer retainer 34 is disposed on the inner circumference of the outer ring part 31. When the outer ring part 31 is in its attached position on the outer retainer 34, the flange 36 on one end of the outer retainer 34 in the axial direction J1 is in contact with an end surface of the outer ring part 31 toward the one end in the axial direction J1, and the flange 36 on an opposite end of the outer retainer 34 in the axial direction J1 is in contact with an end surface of the outer ring part 31 toward the opposite end in the axial direction J1. When the outer ring part 31 is in its attached position on the outer retainer 34, the through holes 38 of the outer retainer 34 are in positions respectively corresponding to the grooves 32 of the outer ring part 31.

The integration of the inner ring part 30 and the inner retainer 33 having the inner separators 39, and the integration of the outer ring part 31 and the outer retainer 34 having the outer separators 40 are carried out after the inner ring part 30 has been disposed in the outer ring part 31. Thus, the outer retainer 34 having the outer separators 40 is formed while maintaining the teeth 7 inserted in the grooves 32 of the outer ring part 31 and extending through the through holes 38 of the outer retainer 34. As described above, two through holes 38 of the outer retainer 34 are located between each pair of adjacent outer separators 40. Thus, the outer separators 40 are located in the spaces between the teeth 7 adjacent to each other where the inner separators 39 are not located. As described above, in the third embodiment, the spaces between the teeth 7 adjacent to each other where the inner separators 39 are located and the spaces between the teeth 7 adjacent to each other where the outer separators 40 are located are arranged alternately in the circumferential direction. It should be noted that the inner separators 39 and the outer separators 40 are not limited to being arranged alternately in the circumferential direction, and may be changed as appropriate.

In the case of the stator core 1d according to the third embodiment, the stator core 1d has the inner separators 39 and the outer separators 40. As such, the stator core 1d according to the third embodiment can provide insulation between coils 4 on each pair of adjacent teeth 7 using the combination of the inner retainer 33 having the inner separators 39 and the outer retainer 34 having the outer separators 40,

Next, a second modification example of the stator core according to the first embodiment will be described with reference to FIGS. 17 to 19. It should be noted that components assigned the same reference numerals as in the first embodiment each have the same function as described in the first embodiment, and thus description thereof may be omitted below. A stator core 1e of the present modification example differs from that of the first embodiment in the configuration of the insulation part 8.

The stator core 1e has an insulation part 8 that is divisible into a plurality of parts that can be separated from each other around the circumferential direction of a retainer 10 thereof. Specifically, the insulation part 8 has a plurality of segments 41. In this case, the retainer 10 has a plurality of plate-like portions 42. As shown in FIG. 19, each of the segments 41 has a plate-like portion 42 and a separator 11. The plate-like portion 42 has a substantially rectangular plate-like shape and is curved in an arc that bulges outward in the radial direction of a ring part 6. The plate-like portion 42 has notches 43 at two ends thereof in the circumferential direction. The separator 11 has the same configuration as in the first embodiment described above, and is provided on the outer circumferential surface of the plate-like portion 42. It should be noted that the number of segments may be changed as appropriate.

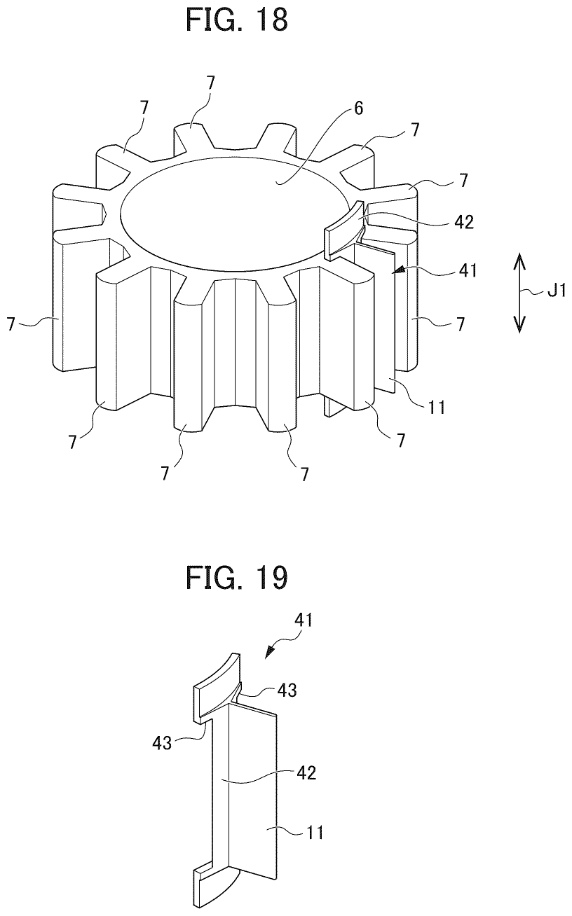

As shown in FIG. 18, each of the segments 41 is attached to the ring part 6 in a position between adjacent teeth 7. Specifically, each of the segments 41 is attached to the outer circumferential surface of the ring part 6 so that the teeth 7 are inserted into the notches 43. When the segment 41 is in its attached position on the ring part 6, the separator 11 thereof is located between the adjacent teeth 7. In this way, the plurality of segments 41 are attached to the ring part 6. Adjacent segments 41 are in contact with each other. Thus, when the insulation part 8 is in its attached position on the ring part 6, the teeth 7 extend through respective through holes 12, each of which is defined by the notch 43 formed in one of adjacent segments 41 and the notch 43 formed in the other of the adjacent segments 41.

In the case of the stator core 1e according to the present modification example, the insulation part 8 is configured to be divisible into a plurality of parts that can be separated from each other around the circumferential direction of the retainer 10. As such, the stator core 1e according to the present modification example has a configuration in which the insulation part 8 is divisible into a plurality of parts that can be separated from each other, and these parts are united into one part, so that the teeth 7 protrude from the ring part 6 outward in the radial direction. This configuration facilitates the attachment of the insulation part 8 to the ring part 6.

Next, a second modification example of the stator core according to the second embodiment will be described with reference to FIGS. 20 to 22. It should be noted that components assigned the same reference numerals as in the first and second embodiments each have the same function as described in the first and second embodiments, and thus description thereof may be omitted below. A stator core 1f of the present modification example differs from that of the second embodiment in the configuration of the insulation part 8.

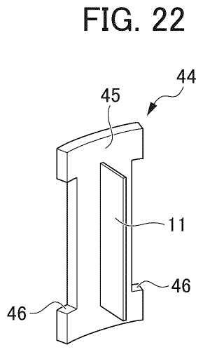

The stator core 1f has an insulation part 8 that is divisible into a plurality of parts that can be separated from each other around the circumferential direction of a retainer 10 thereof. Specifically, the insulation part 8 has a plurality of segments 44. In this case, the retainer 10 has a plurality of plate-like portions 45. As shown in FIG. 22, each of the segments 44 has a plate-like portion 45 and a separator 11. The plate-like portion 45 has a substantially rectangular plate-like shape and is curved in an arc that bulges outward in the radial direction of a ring part 6. The plate-like portion 45 has notches 46 at two ends thereof in the circumferential direction. The separator 11 has the same configuration as in the second embodiment described above, and is provided on the inner circumferential surface of the plate-like portion 45. It should be noted that the number of segments may be changed as appropriate.

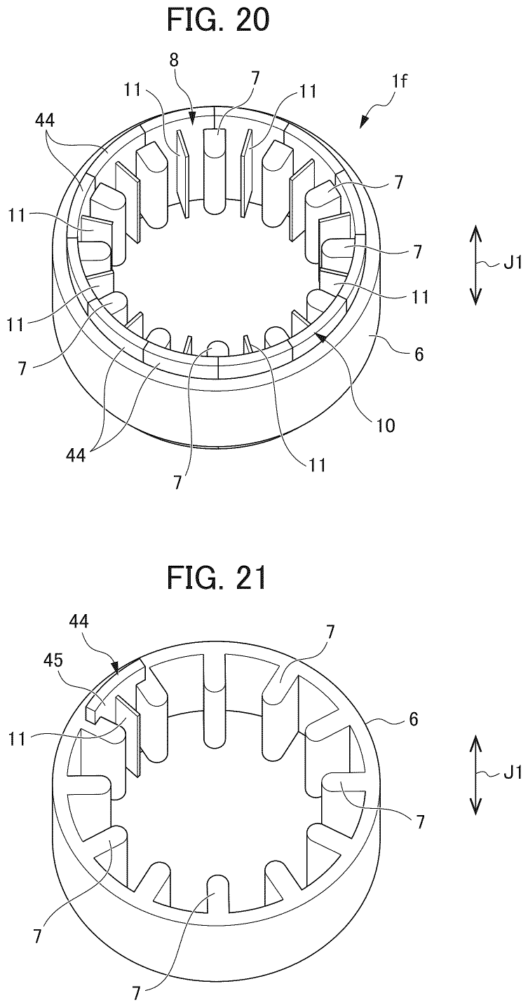

As shown in FIG. 21, each of the segments 44 is attached to the ring part 6 in a position between adjacent teeth 7. Specifically, each of the segments 44 is attached to the inner circumferential surface of the ring part 6 so that the teeth 7 are inserted into the notches 46. When the segment 44 is in its attached position on the ring part 6, the separator 11 thereof is located between the adjacent teeth 7. In this way, the plurality of segments 44 are attached to the ring part 6. Adjacent segments 44 are in contact with each other. Thus, when the insulation part 8 is in its attached position on the ring part 6, the teeth 7 extend through respective through holes 12, each of which is defined by the notch 46 formed in one of adjacent segments 44 and the notch 46 formed in the other of the adjacent segments 44.

In the case of the stator core 1f according to the present modification example, the insulation part 8 is configured to be divisible into a plurality of parts that can be separated from each other around the circumferential direction of the retainer 10. As such, the stator core 1f according to the present modification example has a configuration in which the insulation part 8 is divisible into a plurality of parts that can be separated from each other, and these parts are united into one part, so that the teeth 7 protrude from the ring part 6 inward in the radial direction. This configuration facilitates the attachment of the insulation part 8 to the ring part 6.

According to at least one of the embodiments described above, it is possible to provide a stator core 1 having an insulation part 8 that can facilitate compatibility with small gaps between adjacent coils 4 with a simple configuration, because the insulation part 8 has the configuration described above.

Although the present disclosure has been described in detail above, the present disclosure is not limited to the foregoing individual embodiments. Various changes, such as additions, substitutions, alterations, and partial omissions, may be made to the foregoing embodiments to the extent that such changes do not depart from the gist of the present disclosure, or to the extent that such changes do not depart from the gist of the present disclosure that is derived from the appended claims or the equivalents thereof. Any of the foregoing embodiments can be implemented in combination with each other. For example, the order of operations and the order of processes mentioned in the foregoing embodiments are merely examples, and the present disclosure is not limited thereto. The same applies to numerical values or mathematical formulas that are used in the description of the foregoing embodiments, if any.

### EXPLANATION OF REFERENCE NUMERALS

1: Stator core
4: Coil
6: Ring part
7: Tooth
8: Insulation part
10: Retainer
11: Separator
30: Inner ring part
31: Outer ring part
33: Inner retainer
34: Outer retainer
39: Inner separator
40: Outer separator

1. A stator core comprising:
a circular cylindrical ring part;
a plurality of teeth provided on the ring part and protruding outward in a radial direction or inward in the radial direction;
coils provided on the teeth; and
an insulation part that provides insulation between the coils on each pair of adjacent teeth,
the insulation part including
a circular cylindrical retainer disposed on the ring part, and
separators provided on the retainer and protruding in the radial direction, the separators separating each pair of adjacent coils from each other.

2. The stator core according to claim 1, wherein
the plurality of teeth are provided on the ring part and protrude outward in the radial direction,
the retainer is disposed on an outer circumference of the ring part, and
the separators are provided on the retainer and protrude outward in the radial direction.

3. The stator core according to claim 1, wherein
the plurality of teeth are provided on the ring part and protrude inward in the radial direction,
the retainer is disposed on an inner circumference of the ring part, and
the separators are provided on the retainer and protrude inward in the radial direction.

4. The stator core according to claim 2, wherein the insulation part is divisible into two parts that can be separated from each other in an axial direction of the retainer.

5. The stator core according to claim 1, wherein
the ring part includes a circular cylindrical inner ring part and a circular cylindrical outer ring part that are arranged one inside the other in a nested manner,
the plurality of teeth are provided on the inner ring part and protrude outward in the radial direction,
the retainer includes a circular cylindrical inner retainer disposed on an outer circumference of the inner ring part, and a circular cylindrical outer retainer disposed on an inner circumference of the outer ring part, and
the separators include inner separators provided on the inner retainer and protruding outward in the radial direction, and outer separators provided on the outer retainer and protruding inward in the radial direction.

6. The stator core according to claim 2, wherein the insulation part is divisible into a plurality of parts that can be separated from each other around a circumferential direction of the retainer.

7. The stator core according to claim 3, wherein the insulation part is divisible into two parts that can be separated from each other in an axial direction of the retainer.

8. The stator core according to claim 3, wherein the insulation part is divisible into a plurality of parts that can be separated from each other around a circumferential direction of the retainer.
